(19) United States
(12) Patent Application Publication
(10) Pub. No.: US 2015/0333545 A1
(43) Pub. Date: Nov. 19, 2015

(54) Secure Charging Interface

(71) Applicant: ASTRONICS ADVANCED ELECTRONIC SYSTEMS CORP., Kirkland, WA (US)

(72) Inventor: Thomas R. Luce, Bothell, WA (US)

(73) Assignee: ASTRONICS ADVANCED ELECTRONIC SYSTEMS CORP., Kirkland, WA (US)

(21) Appl. No.: 14/279,239

(22) Filed: May 15, 2014

(51) Int. Cl. H02J 7/00

(52) U.S. Cl. CPC H02J 7/0029; H02J 7/0052; H02J 7/007; H02J 2007/0001; H02J 2007/0096

(57) ABSTRACT

An interconnection unit disposed between an electric device (ED) and a host power source, including an isolation unit, an ED connector that is configured to electrically interconnect the ED and the isolation unit, and a power connector that is configured to electrically interconnect the host power source and the isolation unit. The isolation unit prevents unauthorized access of the ED by the host power source during the charging process.

### FIELD OF THE DISCLOSURE

The subject matter of the present disclosure generally relates to charging interfaces, and more particularly relates to secure charging interfaces for electronic devices that contain data.

### BACKGROUND OF THE DISCLOSURE

The importance and accompanying difficulty of protecting corporate and personal data continues to present new challenges as technology use becomes increasingly widespread. Simultaneously, the number and types of electronic devices (EDs), such as smartphones and tablet computers, have grown exponentially. For many users EDs have become an integral part of everyday life.

EDs are used to access and store information both mundane and invaluable. For individuals, this includes banking information, personal communications, and images. Employees receive and transmit corporate data, enter passwords, and access financial information. Government workers may deal with state secrets and tactical or intelligence data. Therefore, the implications of a compromised ED may range from personal inconvenience to serious security breaches.

Often, EDs are charged using the same connector that is used to transmit data. This situation provides a potential point of access for tapping, hacking, or passively intercepting data from an ED if it is plugged into a compromised charging device. EDs often communicate digitally with their host to handshake and tailor electrical input, requiring an exchange of data. Furthermore, in some instances an ED possessing separate data and power lines may nonetheless unintentionally make vulnerable certain information via a charging conduit. Unsecured power or data circuits may pass electrical signals betraying phone data such as display content, user input, audio signals, and wireless communication data. Thus, every time an ED is plugged into a charger, there is a chance that the device supplying power is maliciously controlled or monitored in some way and that the ED could be compromised.

These concerns are especially prevalent in public locations such as airports, public transportation, hotels, computers, and even stereo systems. Illicit access techniques include directly accessing data (hacking), intercepting and monitoring data (tapping), and monitoring radiated or conducted electrical signals and/or noise (phreaking) Various specific techniques will be apparent to those of skill in the art to which this disclosure pertains.

The subject matter of the present disclosure is directed to overcoming, or at least reducing the effects of, one or more of the problems set forth above.

### BRIEF SUMMARY OF THE DISCLOSURE

Disclosed is an apparatus and method for protecting an electronic device (ED) from unauthorized access.

In an embodiment, an interconnection device is provided, preferably by a trusted source, such as a respected manufacturer. The interconnection device serves as a medium between a host power source and an ED, allowing the ED to be charged securely by preventing unauthorized access of data contained on the ED. Depending on the specific implementation, the interconnection device may be integrated into a broader power supply system or may be a separate detachable secure interconnect (DSI), commonly referred to as a ‘dongle,’ that users may carry with them, so as to protect against potential threats in myriad environments.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a block diagram of an exemplary interconnection unit;

FIG. 2 is a block diagram of an exemplary interconnection unit showing data and power lines;

FIG. 3 is an illustration of an exemplary interconnection unit that is a DSI; and

FIG. 4 is a block diagram of an exemplary interconnection unit integrated into a power supply system.

Like reference numbers and designations in the various drawings indicate like elements.

### DETAILED DESCRIPTION

Disclosed is an apparatus and method for protecting an ED while it is charging.

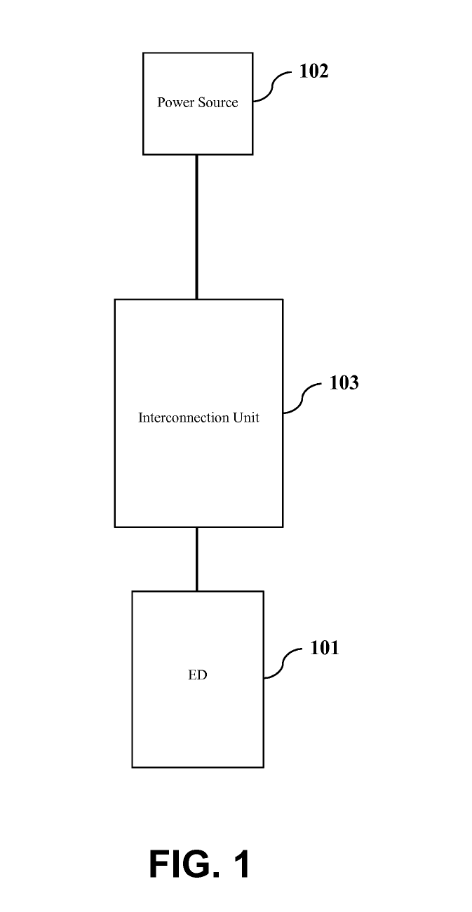

Referring to FIG. 1 that provides a high-level block diagram of an embodiment in use, ED 101 is charged using power source 102. However, as opposed to ED 101 being directly coupled to power source 102, ED is coupled to interconnection unit 103, which serves as a medium to power source 102 and protects data contained on ED 101. Protected data may reside in various components of an ED, such as in removable memory cards, flash storage, hard drives, etc.

Generally, EDs should be broadly understood to include such devices as cellular phones (including smartphones), tablet computers, laptops, personal digital assistants, digital cameras, Bluetooth-connectable devices, wearable devices such as smart watches, and other comparable devices. Components may be electrically coupled in various embodiments via numerous connectors such as those adhering to standards such as Universal Serial Bus (USB) 2.0 or 3.0, mini-USB, micro-USB, FireWire, eSATA, Gigabit Ethernet, THUNDERBOLT (Intel Corporation, Santa Clara, Calif.), LIGHTNING (Apple Inc., Cupertino, Calif.), etc. Alternatively, connections may be basic wired connections or utilize circuitry components.

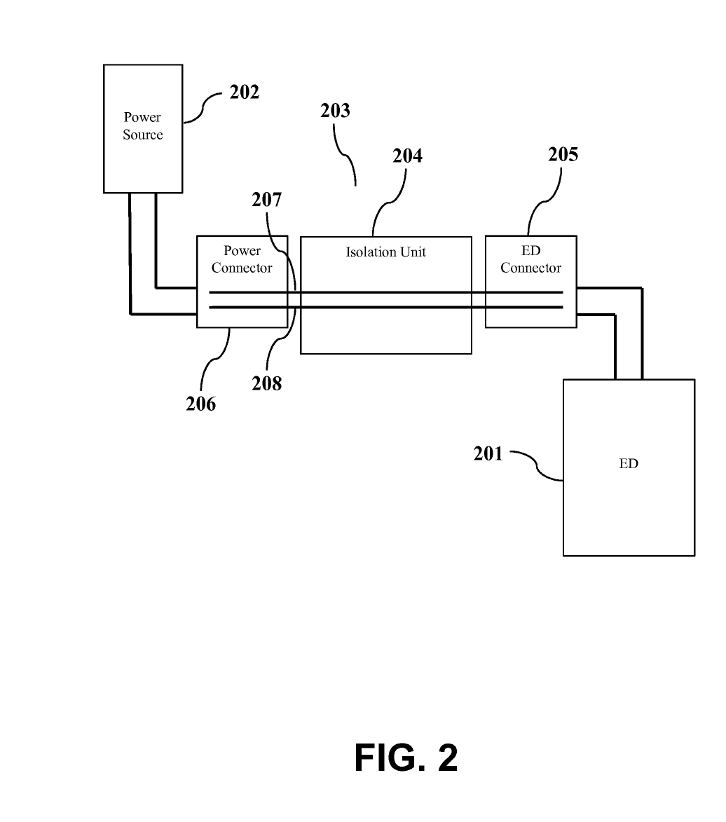

Referring to FIG. 2, ED 201 is charged using power source 202. Interconnection unit 203 includes isolation unit 204, ED connector 205 and power connector 206. ED connector 205 serves as an interface between ED 201 and isolation unit 204, while power connector 206 serves as an interface between power source 202 and isolation unit 204. In the embodiment, power line 207 and data line 208 run through ED connector 205, isolation unit 204 and power connector 206. During the process of charging, isolation unit 204 prevents unauthorized access of ED 201 by host power source 202. ED connector 205 may optionally be a plug-terminated cable or wiring harness interface.

In an exemplary embodiment, the isolation unit serves to prevent any flow of data between the ED and the power source by physically terminating the data output of the ED.

In another exemplary embodiment, the isolation unit limits data communication between the host power source and the ED to charge-related communication by electrically isolating the digital and charging connections.

In another exemplary embodiment, the isolation unit prevents unauthorized access of the ED by controlling electrical fluctuations across the data line and the power line. This functionality serves to prevent electrical signals from betraying phone data. This may be accomplished by the isolation unit's production of masking signals on the data line and/or the power line. Specifically, such masking or flooding can be accomplished using specific, pseudo-random or random signals or noise.

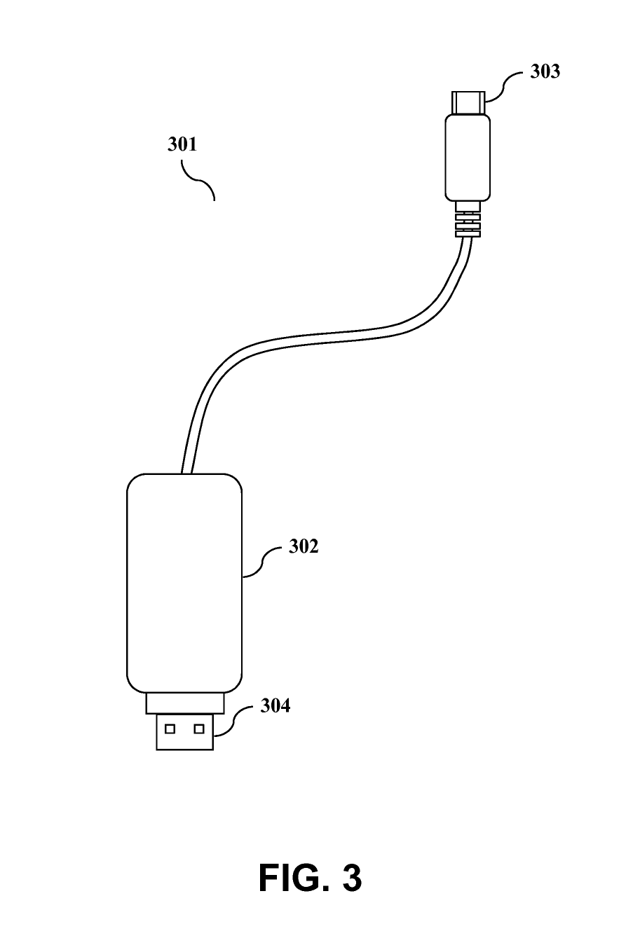

Referring to FIG. 3, interconnection unit 301 is a DSI that includes isolation unit 302, ED connector 303, and power connector 304. In the embodiment, ED connector 303 is a micro-USB type connector and power connector 304 is a USB type connector. Interconnection unit 301 thus may be detached from an ED and power source so that, for instance, a user can take the DSI with them to secure otherwise untrustworthy power sources.

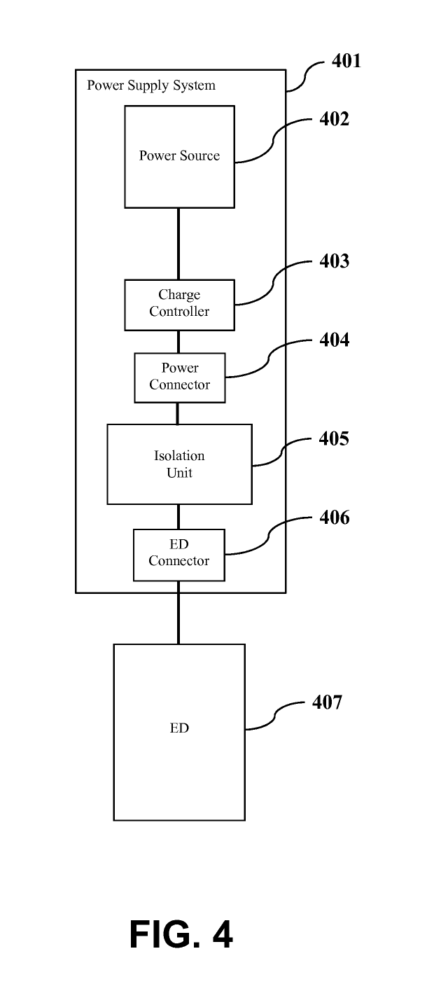

Referring to FIG. 4, power supply system 401 has integrated with it power source 402, charge controller 403, power connector 404, isolation unit 405, and ED connector 406. ED 407 is protected from possible security issues due to monitoring or listening occurring in the system by isolation unit 405. In the embodiment, power connector 404 is merely an outgoing power line from charge controller 403 to isolation unit 405 and ED connector 406 is a power outlet. Such an integrated system can ensure users that their charging interface is ‘clean’ or secure, encouraging user trust and use. Preferably, charge controller 403 has been verified to impart no additional security threats. For instance, the trusted manufacturer of power supply system 401 may examine the die architecture of charge controller 403 and certify that it does not contain unintentionally insecure features, such as ‘back door’ circuitry components.

In an alternate embodiment, charge controller 403 may be interposed between isolation unit 405 and ED connector 406. In such an embodiment, verification of charge controller 403 may take on additional importance stemming from more direct disposition in the power supply system in relation to ED 407.

Several of the above described functionalities can be implemented alone or in combination to provide a wide range of protection for user EDs. Several of the above described functionalities may be implemented via physical distancing and isolation, line filtering, use of opto-isolators, use of general purpose, custom or programmable ASICs, and other means. Accompanying certification may optionally be employed to engender user trust.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. An interconnection unit disposed between an electric device (ED) and a host power source, comprising:
an isolation unit;
an ED connector, configured to electrically interconnect the ED and the isolation unit;
a power connector, configured to electrically interconnect the host power source and the isolation unit; and
the isolation unit being effective to prevent unauthorized access to data contained on the ED via the host power source connection.

2. The interconnection unit of claim 1, wherein the ED and the host power source are interconnected by a data line and a power line, each running through the ED connector, isolation unit and power connector.

3. The interconnection unit of claim 1, wherein the isolation unit limits data communication between the host power source and the ED to charge-related communication.

4. The interconnection unit of claim 2, wherein the isolation unit prevents unauthorized access of the ED by controlling electrical fluctuations across the data line and the power line.

5. The interconnection unit of claim 2, wherein the isolation unit is configured to produce an amount of masking signals on at least one of the data line and the power line.

6. The interconnection unit of claim 5, wherein the masking signals are selected from the group of pseudo-random and random noise.

7. The interconnection unit of claim 1, further comprising a charging controller verified to impart no additional security threats.

8. The interconnection unit of claim 1, wherein the isolation unit, ED connector and power connector are contained in a detachable secure interconnect (DSI) that is detachable from the ED and the host power source.

9. The interconnection unit of claim 1, wherein the host power source, isolation unit, ED connector and power connector are integrated in a power supply system.

10. A method for protecting data on an ED while it is electrically connected with a host power source, comprising the steps of:
electrically interconnecting the ED and an ED connector of an interconnection unit;
electrically interconnecting the host power source and a power connector of the interconnection unit;
the interconnection unit having an isolation unit; and
facilitating the charging of the ED using power from the host power source while preventing unauthorized access to data contained on the ED via the host power source connection.

11. The method of claim 10, wherein the ED and the host power source are interconnected by a data line and a power line, each running through the ED connector, isolation unit and power connector.

12. The method of claim 10, wherein the isolation unit limits data communication between the host power source and the ED to charge-related communication.

13. The method of claim 11, wherein the step of preventing unauthorized access of data includes controlling electrical fluctuations across the data line and the power line.

14. The method of claim 11, wherein the step of preventing unauthorized access of data includes producing using the isolation unit an amount of masking signals on at least one of the data line and the power line.

15. The method of claim 14, wherein the masking signals are selected from the group of pseudo-random and random noise.

16. The method of claim 10, wherein a charging controller has been verified to impart no additional security threats.

17. The method of claim 10, wherein the isolation unit, ED connector and power connector are contained in a DSI that is detachable from the ED and the host power source.

18. The method of claim 10, wherein the host power source, isolation unit, ED connector and power connector are integrated in a power supply system.
